(19) United States
(12) Patent Application Publication
(10) Pub. No.: US 2015/0222224 A1
(43) Pub. Date: Aug. 6, 2015

(54) FLEXIBLE BUILDING INTEGRATED PV DEVICE

(71) Applicants: Onkareshwar V. Bijjargi, Pimple Saudagar Pune (IN); Siddharth Ram R. Athreya, Lake Jackson, TX (US); Edoardo Nicoli, Midland, MI (US); Hua Liu, Pitsford, NY (US); Keith L. Kauffmann, Ypsilanti, MI (US); Jie Feng, Midland, MI (US); Leonardo C. Lopez, Midland, MI (US); Rebekah K. Feist, Midland, MI (US); Rahul Sharma, Pearland, TX (US)

(72) Inventors: Onkareshwar V. Bijjargi, Pimple Saudagar Pune (IN); Siddharth Ram R. Athreya, Lake Jackson, TX (US); Edoardo Nicoli, Midland, MI (US); Hua Liu, Pitsford, NY (US); Keith L. Kauffmann, Ypsilanti, MI (US); Jie Feng, Midland, MI (US); Leonardo C. Lopez, Midland, MI (US); Rebekah K. Feist, Midland, MI (US); Rahul Sharma, Pearland, TX (US)

(73) Assignee: Dow Global Technologies LLC, Midland, MI (US)

(21) Appl. No.: 14/407,112

(22) PCT Filed: Jul. 5, 2012
(86) PCT No.: PCT/IN2012/000474

§ 371 Date: Apr. 10, 2015

(51) Int. Cl. H02S 20/26

(52) U.S. Cl. CPC H02S 20/26

(57) ABSTRACT

An article of manufacture includes at least two solar active elements separated by a gap, with a flexible material provided to define the gap. The article provides for enhanced resilience and conformity to an installation surface.

### FIELD

The present invention relates to improved photo-voltaic devices, and more particularly but not exclusively relates to photo-voltaic devices having an enhanced conformity and resilience.

### INTRODUCTION

Presently known high efficiency photo-voltaic (PV) devices utilize rigid PV cells and include a rigid transparent sheet. PV cells do not tolerate high deformation, and the rigid transparent sheet is provided thick enough to support the rigidness required of the device. This reduces the flexibility of the overall PV device, providing for reduced conformity, for example, to roof irregularities for devices that are used as shingles. The thickness of the transparent sheet also increases the weight of the PV device. Some PV devices are sized to replace a number of construction units, such as shingles, and therefore result in a large smooth surface, such as a glass surface. The resulting surface can cause slipping problems.

### SUMMARY

The present disclosure in one aspect includes an article of manufacture having a structural base layer defining a unit shape of a construction material unit, a number of solar active elements, where the solar active elements are positioned within a frame of the structural base layer and with a gap between each adjacent solar active element. Each of the solar active elements includes a rigid sheet and a photo-voltaic (PV) cell positioned within a frame of the rigid sheet and opposite the light incident side of the rigid sheet, where each rigid sheet is at least partially transparent. A flexible material defines at least one of the gaps between at least one adjacent pair of the solar active elements. The structural base layer, the solar active elements, and the flexible material are operationally coupled to form the construction material unit.

Additional or alternative aspects of the disclosure may be further characterized by any one or more of the following features: each of the solar active elements having an equal shape; each of the solar elements having an equal area; the rigid sheets defining a plane, where the flexible material extends above the plane within at least one of the gaps; where a number of the solar active elements include a value selected from: between two and eight elements inclusive, between four and sixteen elements inclusive, between eight and thirty-two elements inclusive, between sixteen and sixty-four elements inclusive, and between thirty-six and one hundred elements inclusive; where the construction material unit includes a roofing shingle; where the structural base layer includes a flexible material; where each one of the solar active elements includes a rectangle and where each edge of each rigid sheet extends at least 1 mm past a corresponding edge of each PV cell; where a surface area of each of the solar active elements includes a value between 100 cm² and 1,100 cm²; where a surface area of each of the solar active elements includes a value between 200 cm² and 600 cm²; where a ratio of a total surface area of the rigid sheets to a total area of the PV cells includes a value in the range of 1.0 to 1.2; where a ratio of a total surface area of the rigid sheets to a total area of the PV cells includes a value in the range of 1.05 to 1.18; where each rigid sheet includes a transparent material having a thickness between 0.2 mm and 4.0 mm; where each PV cell includes a crystalline silicon element; and where the flexible material is an overmolded material.

### BRIEF DESCRIPTION OF THE DRAWINGS

FIG. 1 is a schematic diagram of an article of manufacture including two solar active elements formed in a construction material unit.

FIG. 2 is a schematic diagram of an article of manufacture including thirty solar active elements formed in a construction material unit.

FIG. 3 is a schematic diagram of an article of manufacture including seventeen solar active elements formed in a construction material unit.

FIG. 4 is a cutaway side view of an article of manufacture including solar active elements and a number of PV cells.

FIG. 5 is cutaway side view of an article of manufacture including solar active elements, a number of rigid sheets defining a plane, and flexible material positioned between the sheets and protruding above the plane.

FIG. 6 is a schematic diagram of an article of manufacture including four solar active elements formed in a construction material unit.

### DETAILED DESCRIPTION

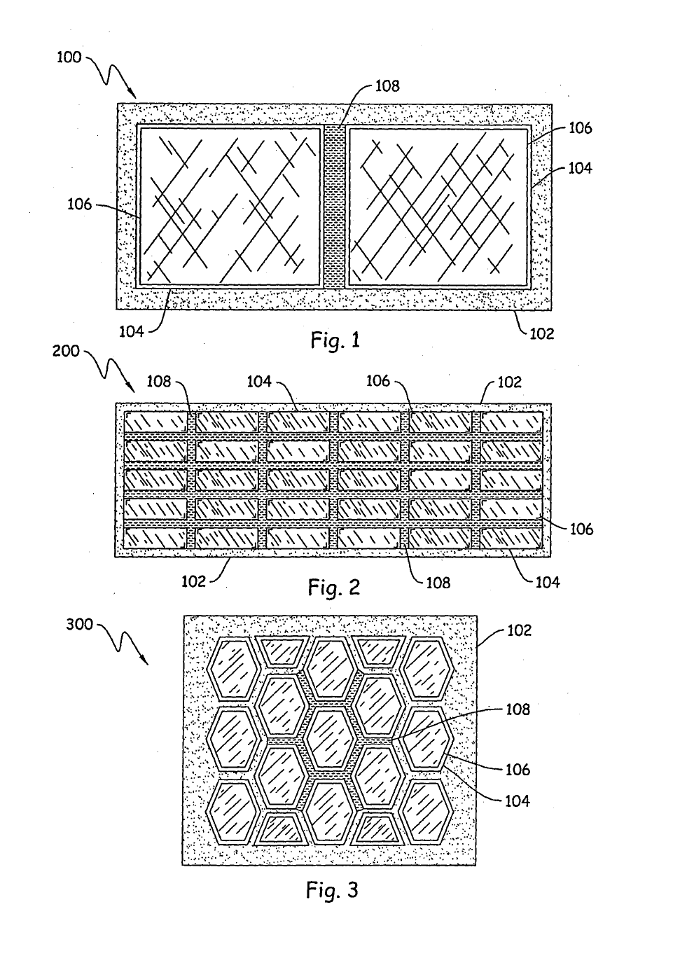

Referencing FIG. 1, an article of manufacture 100 is depicted having two solar active elements. Each solar active element includes a rigid sheet 104 and a photo-voltaic (PV) cell 106 positioned within a frame of the rigid sheet 104 and opposite a light incident side of the rigid sheet 104. The rigid sheet 104 is at least partially transparent, including being transparent to photons within a frequency range relevant to the PV cells 106. Without limitation, the frequency range relevant to the PV cells 106 may include all or any portion of the visible spectrum, infrared light, and/or ultraviolet light. In certain embodiments, the rigid sheet 104 may be provided in more than one layer and/or as a laminated material. The rigid sheet 104 may include protective coatings or layers, anti-reflective coatings, lensing, or other features known in the art. Example and non-limiting materials for the rigid sheet 104 include glass, polymers, oxides and/or ceramics, polymer-oxide pairs, epoxy, resin, and/or glue, and may include multiple layers of some of these in certain embodiments.

In certain embodiments, the rigid sheet 104 has a thickness between 0.2 mm and 4.0 mm, inclusive. The thickness of the rigid sheet 104 is dependent upon the specifications of a particular application, including at least the environmental protection provided by the rigid sheet 104, and the magnitude and impact type of any forces that are to be protected from by the rigid sheet 104. In at least certain embodiments, the thickness of a rigid sheet 104 may be lower than for an otherwise comparable article having a single rigid sheet covering all PV elements in the article. Without limiting any embodiments to a particular theory of operation, the forces experienced by a rigid sheet 104 divided into portions as described herein may be reduced relative to the comparable article due to spreading of the force across several rigid sheets, improved transfer of the forces through the article to the structural base layer 102 and/or to the installation (e.g. a building), and/or due to a lower stress due to the reduced maximal distance from the point of impact on the rigid sheet to the support edge of the rigid sheet. In certain embodiments, the rigid sheet 104 may be thinner than 0.2 mm, and in certain embodiments the rigid sheet 104 may be thicker than 4.0 mm. In certain embodiments, one or more of the rigid sheets 104 may not be the same thickness, for example a rigid sheet 104 that may be expected to be more likely to be impacted may be thicker.

The article 100 further includes the structural base layer 102 defining a unit shape of a construction material unit. A construction material unit is any building integrated construction unit, for example a roofing shingle, a unit of siding for a building, or any other building integrated article. The construction material unit may be a replacement for a single unit, such as a single roofing tile, or for a group of units, such as a segment that integrates into a roof and replaces a number of roofing tiles. The structural base layer 102 defines the shape of the article 100 and provides an interface from the article 100 to the installation (e.g. to a building roof). The structural base layer 102 may provide isolation and/or protection for the PV cells 106, and related electrical assemblies (not shown), from the building (e.g. protruding nails, etc.) and/or the environment (e.g. water intrusion). Additionally or alternatively, the structural base layer 102 may cooperate with one or more other layers in the article 100 to provide isolation and/or protection for the PV cells 106 and related electrical assemblies from the building and/or the environment. In certain embodiments, the structural base layer 102 is not the outside layer that contacts the building or application surface—for example the structural base layer 102 may be an aluminum layer that provides stiffness and physical protection to the underside of a shingle, but other layers below the structural base layer 102 interface directly with the building.

In certain embodiments, the structural base layer 102 is provided as a flexible material, for example to enhance conformation of the article 100 to the installation. Additionally or alternatively, the structural base layer 102 includes flexible portions, and in certain further embodiments, the flexible portions of the structural base layer 102 correspond to gaps provided between adjacent rigid sheets 104. Where the structural base layer 102 is provided as a flexible material and/or includes flexible portions, the flexible material of the structural base layer 102 may be the same or a distinct material from the flexible material 108 positioned between the gaps of the rigid sheets 104. Without limitation, the flexible material making up a portion of the structural base layer 102 may be a stiffer and/or stronger material than the flexible material 108. Any of the materials described for the flexible material 108 may be included as a flexible portion of the structural base layer 102. In certain embodiments, the structural base layer 102 includes thicker materials than the flexible material 108, includes material that is flexible through mechanical design rather than, or in addition to, providing flexibility with material selection (e.g. thinner material at the flexible position, joints provided, etc.).

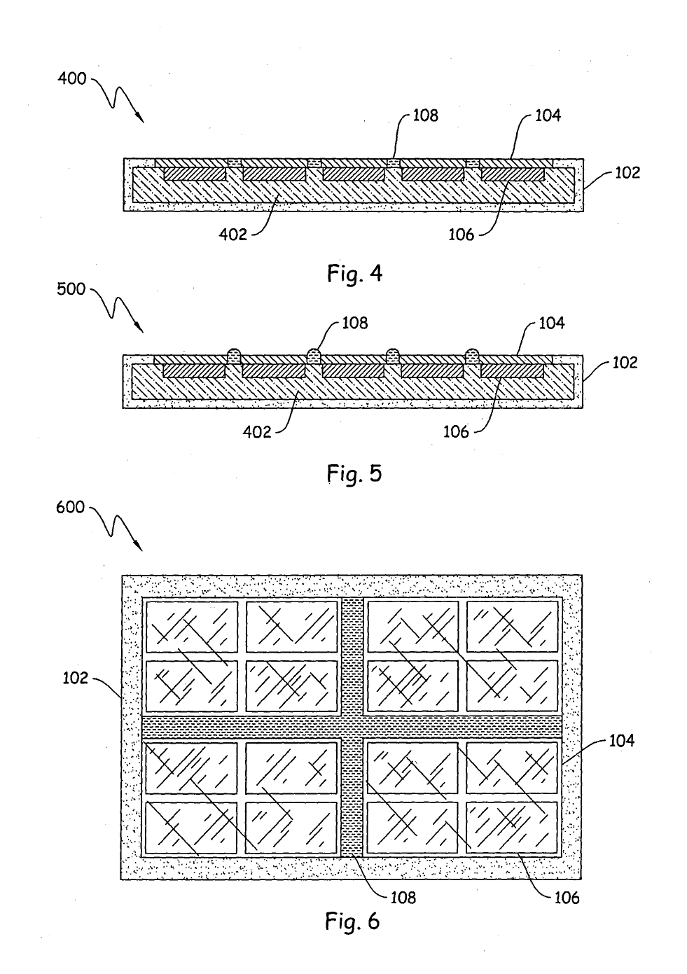

The structural base layer 102 in the example of FIG. 1 is visible from the light incident side of the article 100, however the structural base layer 102 may not be visible from the light incident side of the article 100 in certain embodiments. Referencing FIG. 4, a cutaway side view of an article 400 is depicted including solar active elements and a number of PV cells 106. The article 400 includes the structural base layer 102 forming the sides of the article and being visible from the light incident side of the article 400 (the top side in the orientation shown in FIG. 4). However, the structural base layer 102 may be coupled to a front layer through adhesive, lamination, or any other coupling understood in the art, and thereby would not be visible from the light incident side.

Referencing back to FIG. 1, the article 100 further includes at least one PV cell 106 positioned with a frame of each rigid sheet 104. The article 100 further includes electrical assemblies, as mentioned preceding, which are not depicted for purposes of clarity. The electrical assemblies include electrical connections between PV cells 106, and may further include bus bars and/or external electrical circuit couplings. The PV cells 106 may be arranged in parallel, series, mixed series-parallel, and/or may be provided in independent circuits. The electrical assemblies may be of any type known in the art, and are not limiting to the present disclosure.

The PV cells 106 may be of any type and PV material known in the art. Example and non-limiting PV materials include copper chalcogenide type cells (e.g. copper indium gallium selenides, copper indium selenides, copper indium gallium sulfides, copper indium sulfides, copper indium gallium selenides sulfides, etc.), amorphous silicon cells, crystalline silicon cells, thin-film III-V cells, thin-film II-VI cells, organic photo-voltaics, nanoparticle photo-voltaics, dye sensitized solar cells, and/or combinations of the described materials. In certain embodiments, a PV cell 106 is provided as a PV material deposited on the interior side of the rigid sheet 104. In certain embodiments, one or more of the PV cells 106 may include a distinct PV material from the other PV cells 106. In certain embodiments, each PV cell 106 includes a crystalline silicon element.

The PV cells 106 are positioned within the frame of the rigid sheets 104. The sizing of the PV cells 106 to the rigid sheets 104 depends upon the specific characteristics of the application. In certain embodiments, each edge of the rigid sheet 104 extends at least 1 mm past a corresponding edge of the underlying PV cell 106. Additionally or alternatively, each edge of the rigid sheet 104 may extend at least 2 mm past a corresponding edge of the underlying PV cell 106, and/or at least 5 mm past a corresponding edge of the underlying PV cell 106.

One of skill in the art will recognize that a closer match of the rigid sheet 104 to the PV cell 106 size provides for a greater utilization of the active solar area in terms of electricity generation, and that a greater extension of the rigid sheet 104 past the PV cell 106 can provide for enhanced environmental barrier and/or force transfer protection of the PV cell 106. Simple testing of the type ordinarily performed in the design of a PV device, including impact testing for designed loads and/or environmental testing for designed conditions, combined with the benefit of the disclosures herein, provide one of skill in the art with sufficient information to select a sizing differential between the rigid sheet 104 and the PV cell 106. Where multiple PV cells 106 are provided under a rigid sheet 104, a given PV cell 106 may have less than all sides corresponding to a side of the rigid sheet 104, and a given PV cell 106 may not have any sides corresponding to a side of the rigid sheet 104 such as when a PV cell 106 is centrally located under the rigid sheet 104.

In certain embodiments, a surface area of each of the rigid sheets 104 defining an active solar area includes a value between 100 cm² and 1,100 cm². In certain additional or alternative embodiments, a surface area of each of the rigid sheets 104 defining an active solar area includes a value between 200 cm² and 600 cm². Simple testing of the type ordinarily performed in the design of a PV device, including impact testing for designed loads and/or environmental testing for designed conditions, combined with the benefit of the disclosures herein, provide one of skill in the art with sufficient information to select a sizing value for the rigid sheets 104. In certain embodiments, each rigid sheet 104 is provided with the same shape. In certain embodiments, one or more of the rigid sheets 104 is provided with a distinct shape. Example articles include providing rigid sheets 104 with differing shapes in response to differing expectations for impacts or stresses in the article at the locations of the shapes, and/or to provide for efficient utilization of the article surface area. In certain embodiments, each rigid sheet 104 is provided with the same size. In certain embodiments, one or more of the rigid sheets 104 is provided with a distinct size. Example articles include providing rigid sheets 104 with differing sizes in response to differing expectations for impacts or stresses in the article at the locations of the sizes, and/or to provide for efficient utilization of the article surface area.

In certain embodiments, a ratio of the total surface area of all of the rigid sheets 104 to a total area of all of the PV cells 106 is in the range of 1.0 to 1.2. For example, where the area of the PV cells 106 for an article 100 is 1000 cm², an example article includes a total area of the rigid sheets 104 between 1000 cm² and 1200 cm². In certain embodiments, an area of the total area of the rigid sheets 104 exceeds a ratio of 1.2. In certain embodiments, a ratio of the total surface area of all of the rigid sheets 104 to a total area of all of the PV cells 106 is in the range of 1.05 to 1.18.

The article 100 includes two rigid sheets 104 defining two solar active elements. The size of the article 100 and the selection of a rigid sheet 104 size interact, along with gap sizing, to determine the number of solar active elements in a given article. In certain embodiments, an article includes between two and eight solar active elements, inclusive. In certain embodiments, an article includes between four and sixteen solar active elements, inclusive. In certain embodiments, an article includes between eight and thirty-two solar active elements, inclusive. In certain embodiments, an article includes between sixteen and sixty-four elements, inclusive. In certain embodiments, an article includes between thirty-six and one hundred solar active elements, inclusive. The described ranges are non-limiting examples.

The rigid sheets 104 are positioned with a frame of the structural base layer 102, and include a gap between each adjacent rigid sheet 104. The article 100 further includes a flexible material 108 defining the gap between the adjacent rigid sheets 104. In certain embodiments, the flexible material 108 is provided defining at least one gap between at least one pair of adjacent rigid sheets 104, but the flexible material 108 may not be provided defining every gap between every pair of adjacent rigid sheets 104. In certain embodiments, the flexible material 108 is provided defining each of the gaps between each adjacent pair of rigid sheets 104.

The flexible material 108 may be any type of material understood in the art, including at least a polymeric material, a plastic, a thermoplastic, an elastomeric material, a rubber, a synthetic rubber, and/or combinations of these materials. In certain embodiments, the flexible material 108 may be an overmolded material. An example flexible material 108 includes a polypropylene, potentially filled such as with an inorganic particle (e.g. glass fiber, mica). Another example flexible material 108 includes a filled or unfilled polyurethane (e.g. reaction injection molding grade), an unfilled polypropylene, a cross-linked polyethylene, and/or a flexible polyvinyl chloride material. Yet another example flexible material 108 includes an ethylene propylene diene monomer rubber, and/or a polyolefin elastomer (e.g. ethyleneoctene copolymer). Combinations of any of the described materials may also be included.

Flexible material 108 selection depends upon the specific application, including the current or target processing methods (e.g. injection molding or extrusion may be indicated for manufacturing ease in certain embodiments), and/or compatibility to the intended environment. Environmental considerations include the weather profile in the area (rain, wind, freezing cycle, etc.) and/or the expected accumulated UV exposure over time. Any construction method understood in the art may be utilized to provide the flexible material 108, including, without limitation, applying the flexible material 108 with an adhesive, and providing the flexible material 108 as a laminate layer with protrusions that provide the material 108 within the gaps.

Again referencing FIG. 4, the flexible material 108 is positioned to define the gaps between the rigid sheets 104. Referencing FIG. 5, an alternate and/or additional arrangement of an article 500 is illustrated with the flexible material 108 protruding above a plane defined by the rigid sheets 104. In certain embodiments, one or more gaps include the flexible material 108 filling the gaps, and one or more gaps with the flexible material protruding above the gaps. Without limiting any embodiments to a particular theory of operation, flexible material 108 protrusion above the plane of the rigid sheets 104 can provide a more slip resistant top surface of the article 500, and/or can enhance transfer of impact forces away from the rigid sheet 104 and underlying PV cell 106, and into other structural layers of the article 500 and/or into the installation below the article 500.

Referencing FIG. 2, an example article 200 is depicted having a structural base layer 102, a number of rigid sheets 104 defining solar active areas, and a flexible material 108 provided and defining the gaps between adjacent solar active areas. The article 200 includes a PV cell 106 positioned within the frame of each rigid sheet 104. The article 200 includes thirty solar active areas arranged in a rectangular grid, although the number, shape, and arrangement of the solar active areas in FIG. 2 are non-limiting examples.

Referencing FIG. 3, an example article 300 is depicted having a structural base layer 102, and a number of rigid sheets 104 defining solar active areas. In the example of FIG. 3, the flexible material 108 is provided in several of the gaps between adjacent solar active areas in the central portion of the article 300. Additionally or alternatively, the flexible material 108 may be provided in all of the gaps. The flexible material 108 may be protruding above a plane defined by the rigid sheets 104. The example article 300 includes hexagonal rigid sheets 104, with some of the rigid sheets 104 having a differential shape, for example to enhance utilization of the article 300 surface area.

Again referencing FIG. 4, a cutaway side view of an article 400 is depicted. The arrangement of the rigid sheets 104 is not depicted in FIG. 4. The rigid sheets 104 include the flexible material 108 positioned in the gaps between adjacent rigid sheets 104. The article 400 further includes a substrate 402, which may be one or more laminated layers of the article 400, or other substrate 402 known in the art. In certain embodiments, the substrate 402 includes laminated layers including a barrier layer, one or more encapsulation materials, and/or one or more structural support layers. It is contemplated that certain embodiments of the articles described herein include numerous layers and/or assemblies, for example but not limited to features from various embodiments described in currently pending International patent application No. PCT/US09/042496, incorporated herein by reference in the entirety for all purposes.

Referencing FIG. 6, an example article 600 is depicted having a structural base layer 102, a number of rigid sheets 104 defining solar active areas, and a flexible material 108 provided and defining the gaps between adjacent solar active areas. The article 600 includes a number of PV cells 106 positioned within the frame of each rigid sheet 104. The article 600 includes four solar active areas arranged in a rectangular grid, although the number, shape, and arrangement of the solar active areas in FIG. 6 are non-limiting examples.

Any numerical values recited in the above application include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, further including from 20 to 80, also including from 30 to 70, it is intended that values such as 15 to 85, 22 to 68, 43 to 51, 30 to 32 etc. are expressly enumerated in this disclosure. One unit is considered to be the most precise unit disclosed, such as 0.0001, 0.001, 0.01 or 0.1 as appropriate. These are only examples of what is specifically intended and all possible combinations of numerical values between the lowest value and the highest value enumerated are to be considered to be expressly stated in this disclosure in a similar manner.

Unless otherwise stated, all ranges include both endpoints and all numbers between the endpoints. The disclosures of all articles and references, including patent applications and publications, are incorporated by reference for all purposes. The use of the terms “comprising” or “including” describing combinations of elements, ingredients, components or steps herein also contemplates embodiments that consist essentially of the elements, ingredients, components or steps. The use of the articles “a” or “an,” and/or the disclosure of a single item or feature, contemplates the presence of more than one of the item or feature unless explicitly stated to the contrary.

Example embodiments of the present invention have been disclosed. A person of ordinary skill in the art will realize however, that certain modifications to the disclosed embodiments come within the teachings of this disclosure. Therefore, the following claims should be studied to determine the true scope and content of the invention.

What is claimed is:

1: An article of manufacture which is a building integrated photovoltaic device, comprising:
a structural base layer defining a unit shape of a construction material unit;
a plurality of solar active elements, each of the solar active elements comprising a rigid sheet and a photo-voltaic (PV) cell positioned within a frame of the rigid sheet, each rigid sheet being at least partially transparent, wherein the solar active elements are positioned within a frame of the structural base layer and with a gap between each adjacent solar active element;
a flexible material defining at least one of the gaps between at least one adjacent pair of the solar active elements;
wherein the structural base layer, the solar active elements, and the flexible material are operationally coupled to form the construction material unit and wherein the structural base layer is flexible or a portion of the structural base layer includes flexible portions corresponding to the gaps such that the article can conform to an building to which it is attached.

2: The article of manufacture according to claim 1, wherein each of the solar active elements comprises an equal shape.

3: The article of manufacture according to claim 1, wherein each of the solar active elements comprises an equal area.

4: The article of manufacture according to claim 1, wherein the rigid sheets define a plane, and wherein the flexible material extends above the plane within at least one of the gaps.

5: The article of manufacture according to claim 1, wherein a number of the solar active elements comprise a value selected from the values consisting of:
between two and eight elements inclusive, between four and sixteen elements inclusive, between eight and thirty-two elements inclusive, between sixteen and sixty-four elements inclusive, and between thirty-six and one hundred elements inclusive.

6: The article of manufacture according to claim 1, wherein the construction material unit comprises a roofing shingle.

7. (canceled)

8: The article of manufacture according to claim 1, wherein each one of the solar active elements comprises a rectangle, and wherein each edge of each rigid sheet extends at least 1 mm past a corresponding edge of each PV cell.

9: The article of manufacture according to claim 1, wherein a surface area of each of the solar active elements comprises a value between 100 cm² and 1,100 cm².

10: The article of manufacture according to claim 1, wherein a surface area of each of the solar active elements comprises a value between 200 cm² and 600 cm².

11: The article of manufacture according to claim 1, wherein a ratio of a total surface area of the rigid sheets to a total area of the PV cells comprises a value in the range of 1.0 to 1.2.

12: The article of manufacture according to claim 1, wherein a ratio of a total surface area of the rigid sheets to a total area of the PV cells comprises a value in the range of 1.05 to 1.18.

13: The article of manufacture according to claim 1, wherein each rigid sheet comprises a transparent material having a thickness between 0.2 mm and 4.0 mm.

14: The article of manufacture according to claim 1, wherein each PV cell comprises a crystalline silicon element.

15: The article of manufacture according to claim 1, wherein the flexible material is an overmolded material.
